(19) United States
(12) Patent Application Publication
(10) Pub. No.: US 2006/0179118 A1
(43) Pub. Date: Aug. 10, 2006

(54) Platform-specific application user interface remoting

(76) Inventor: Vlad Stirbu, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/330,699

(22) Filed: Jan. 11, 2006

Related U.S. Application Data
(63) Continuation-in-part of application No. 11/035,424, filed on Jan. 12, 2005.

(51) Int. Cl. G06F 15/16; G06F 3/00; G06F 17/00; G06F 9/00

(52) U.S. Cl. 709/217; 715/740

(57) ABSTRACT

This invention relates to a server-site method, a client-site method, computer program products, a client, a server, a module and a system for remoting a user interface of an application between a server that executes said application and at least one client on which a representation of said user interface is to be rendered, wherein said representation of said user interface is generated at said server under consideration of a user interface description that is specific for a device platform of said at least one client; and wherein said representation of said user interface is transferred to said at least one client. Said representation of said user interface may for instance be a memory model representation or a frame buffer representation.

### CROSS-REFERENCE TO RELATED APPLICATION

This application is a Continuation-in-Part of U.S. patent application Ser. No. 11/035,424 filed on Jan. 12, 2005.

### FIELD OF THE INVENTION

This invention relates to a server-site method, a client-site method, computer program products, a client, a server, a module and a system for remoting a user interface of an application between a server that executes said application and a client on which a representation of said user interface is to be rendered.

### BACKGROUND OF THE INVENTION

With the addition of Device Plug and Play (PnP™) capabilities to the operating system of Personal Computers (PCs) it has become easier to set up, configure and add peripheral devices such as printers or multimedia devices to a PC. Universal Plug and Play (UpnP™) extends this simplicity to include the entire network, enabling discovery and control of devices, including networked devices and services, such as network-attached printers, Internet gateways, and consumer electronics equipment.

UPnP is designed to support zero-configuration networking and automatic discovery for a plurality of device categories from a wide range of vendors. With UPnP, a device may for instance dynamically join an ad-hoc or unmanaged network, obtain an IP address, convey its capabilities, and learn about the presence and capabilities of other devices automatically. Devices may subsequently communicate with each other directly for the purpose of control or data exchange, thereby further enabling peer-to-peer networking. A variety of device types can benefit from a UPnP enabled network, as for instance intelligent appliances, wireless devices (e.g. mobile phones or PDAs), and PCs of all form factors. The scope of UPnP is large enough to encompass many existing, as well as new scenarios including home automation, printing and imaging, audio/video entertainment, kitchen appliances, automobile networks, and proximity networks in public venues.

In the context of UPnP, the UPnP Remote User Interface Working Committee has defined a framework that enables a server that is executing an application to export the User Interface (UI) of said application to a remote client, a process that will be denoted as remoting of a UI between a server and a client throughout this specification. An example for remoting of a UI is the displaying of controls and alerts (i.e. the UI) of a home security system (i.e. the server) on a television screen (i.e. the client).

UPnP supports interaction of a variety of device platforms. The UI capabilities supported by these device platforms vary significantly: the most simple device platforms will not have any UI at all, whereas at the top range, there will be device platforms that support very appealing U's. In order to smoothly enable remoting of UIs between devices of a UPnP infrastructure, it is thus required to adapt the remoted UI to the UI capabilities supported by the device platforms.

Furthermore, customizing the remoted UI to match the characteristic display style (the so-called look & feel) of a device platform is of particular importance. If a device platform provides an own UI framework for controlling and rendering a local UI for its local application(s), said characteristic display style may for instance be the characteristic appearance of said local UI. From a user's point of view, this customizing of the remoted UI is important because the remoted UI of a remote application then is perceived by the user like the local UI of a local application of said device platform, appears familiar and may be intuitively useable. From a manufacturer's point of view, this customizing of the remoted UI is of interest because it allows to include the manufacturer's branding elements (like logos or banners) into the remoted UI.

However, prior art protocols that allow remoting of UIs, like for instance Microsoft's Remote Desktop Protocol (RDP), neither allow adaptation of remoted UIs to the UI capabilities of different remote device platforms, nor allow customisation of remoted UIs to match the characteristic display style of different emote device platforms.

### SUMMARY OF THE INVENTION

In view of the above-mentioned problem, it is, inter alia, an object of the present invention to provide improved methods, computer program products, a client, a server, a module and a system for remoting a user interface of an application between a server and a client.

A server-site method is proposed for remoting a user interface of an application between a server that executes said application and at least one client on which a representation of said user interface is to be rendered, said method comprising generating said representation of said user interface at said server under consideration of a user interface description that is specific for a device platform of said at least one client; and transferring said representation of said user interface to said at least one client.

Therein, said server and said at least one client may represent any type of electronic device, and may be connected by means of a wired or wireless connection, which may at least partially be controlled by a remoting protocol. At least said server executes an application that may be controlled by a user via a user interface. Equally well, said user interface may be a passive user interface that only conveys information on said application without offering interaction possibilities. Said application may for instance represent the main functionality of said server, for instance, if said server is a video recorder, said application may refer to the displaying of video streams. Said user interface may for instance be a Graphical User Interface (GUI) that can be displayed to the user on a display, like a menu, and the user then may interact with said user interface, for instance by selecting menu items of said menu. Said user interface may for instance be composed of a plurality of widgets, wherein a widget is understood as an element of a user interface that displays information or provides a specific way for a user to interact with an application. Widgets may for instance comprise icons, pull-down menus, buttons, selection boxes, progress indicators, on-off checkmarks, scroll bars, windows, window edges (that allow a user to resize a window), toggle buttons, forms, and any other elements for displaying information and for inviting, accepting, and responding to user actions.

Said user interface may be remoted, i.e. it is not rendered at said server, but at said at least one client. This may for instance be due to the fact that the server does not provide means for rendering said user interface, or because said server is part of a network in which mutual control of devices and/or data transfer between devices is desired, such as for instance in a UPnP network. To remote said user interface, a representation of said user interface is generated at said server, transferred to the at least one client, and then rendered at the at least one client.

In order to enable adaptation of said representation of said user interface to the user interface capabilities of said at least one client and/or to the characteristic display style (look & feel) of said at least one client, for instance the characteristic appearance of a local user interface (or other remoted user interfaces) on said at least one client, said user interface description is considered during said step of generating said representation of said user interface at said server. Said user interface description may for instance describe how said representation of said user interface should look like when it is remoted on said at least one client, wherein said at least one client is characterised by its device platform, and wherein said device platforms may for instance be defined by the client device manufacturer and/or client device series and/or client device model, and may be identified by a specific device platform ID or the like. Said platform-specific user interface description may for instance define the complete layout of widgets of said representation of said user interface for rendering on said at least one client. Therein, in particular the style and/or colour and/or further features of said widgets that are characteristic for a display style of said at least one client may be considered as well as features like resolution and navigation style. By defining said layout of widgets, said user interface description inherently also allows adaptation of said representation of said user interface to the user interface capabilities of said at least one client, because only those widgets that are supported by the at least one client's device platform will be contained in said user interface description.

The generated representation of said user interface then is transferred from said server to said at least one client in order to be rendered on a display of said at least one client.

Thus according to the present invention, it is possible to adapt a representation of a user interface, which is to be remoted on said at least one client, to the UI capabilities and/or the characteristic display style (look & feel) of a specific device platform of said at least one client. This adaptation is based on said platform-specific user interface description, which may for instance be stored in said server for a variety of device platforms, respectively, and allows a remoting of user interfaces between a variety of devices with heterogeneous device platforms. As the user interface description is separate from the application code, it is possible to add user interface descriptions of new devices, for instance to a database of said server.

According to an embodiment of the server-site method of the present invention, said representation of said user interface is a memory model representation of said user interface, and said memory model representation is transferred to said at least one client by first transferring an initial state of said memory model representation to said at least one client, and then transferring only information on changes in said memory model representation to said at least one client.

Compared to a straightforward approach of completely transferring said representation of said user interface from said server to said at least one client each time when changes in said user interface occur, using a memory model representation and transferring only information on changes (or updates) in said memory model representation after said transfer of said initial state of said memory model representation according to the present invention significantly reduces the amount of network traffic caused by said server. Said at least one client may then reconstruct said memory model representation from said obtained initial state and said obtained information on changes, and may further process said memory model representation. Said further processing may for instance comprise mapping said widget set described by said memory model representation to said at least one client's own widget set and displaying said mapped widget set via said at least one client's local user interface framework.

Furthermore, for instance, the memory model representation may be enhanced by comprising not the content of each user interface element of the corresponding user interface description. Thus, it would be possible to mark at least one user interface element of the corresponding user interface description as optional and to transfer the content of the remaining user interface elements within the enhanced memory model representation without transferring the content of said at least one user interface element marked optional, leading to reduced network traffic and to decreased power consumption in said at least one client receiving said enhanced memory model representation. In particular, in case that at least one of said at least one client is represented by a mobile client, this decreased power consumption increases battery lifetime. At least one of said at least one client receiving said enhanced memory model may decide whether or not to download runtime content of at least one of said at least one user interface element marked optional. Furthermore, the user interface elements in the enhanced memory model may contain a property that points to the runtime content, in particular, said at least one user interface element marked optional in said enhanced memory model may comprise a runtime pointer to the content of said at least one user interface element marked optional. Thus, if said at least one of said at least one client selects at least one of said at least one user interface element marked optional for download, the runtime content of said at least one selected element may be transferred to said at least one of said at least one client by using the runtime pointer to the runtime content of said at least one selected element.

According to a further embodiment of the server-site method of the present invention, said representation of said user interface is a frame buffer representation of said user interface, and said frame buffer representation enables placement of said frame buffer representation in a frame buffer of said at least one client for rendering.

Said frame buffer representation of said user interface obeys a frame buffer format. Therein, said frame buffer, which may for instance be a Video Random Access Memory (VRAM), may be a dedicated buffer used to temporarily store image data destined for a display of said at least one client. Said frame buffer may for instance be organized as a rectangular array of picture elements (pixels) that correspond to the raster of pixels of a display unit of said at least one client, and the frame buffer format then may be defined by said array of pixels and the way in which said pixels are assigned a colour. Contents of such a frame buffer, like said frame buffer representation of said user interface according to the present invention, may be subsequently rendered, wherein said rendering may be understood to comprise digital-to-analog conversion (for instance by a Random Access Memory Digital-to-Analog Converter, RAMDAC) to obtain an analog signal and displaying of said analog signal via a presentation mechanism such as for instance a cathode ray tube, a liquid crystal display, a plasma display, or any other display unit, but may exclude further reformatting of said representation of said user interface.

Thus according to this embodiment of the present invention, as said representation of said user interface is a frame buffer representation, said at least one client may only require means to obtain said representation of said user interface, a frame buffer and possibly some kind of frame buffer control in order to be able to render said representation of said user interface. This allows for a vastly simplified architecture of said at least one client compared to prior art, while still maintaining the advantage that the remoted user interface can be adapted to the client's device platform. In particular, said at least one client then may be a so-called “thin” client with only limited processing power and/or without an own user interface framework, so that it is not capable of rendering said memory model representation of said user interface.

According to a further embodiment of the server-site method of the present invention, said frame buffer representation of said user interface is generated from a memory model representation of said user interface, wherein said memory model representation can be transferred to said at least one client by first transferring an initial state of said memory model representation to said at least one client, and then transferring only information on changes in said memory model representation to said at least one client.

Said memory model representation of said user interface may for instance be transferred by said server to a client that is capable of reconstructing said memory model representation from said obtained initial state and said obtained information on changes, to map a widget set described by said memory model representation to this client's own widget set and to display this mapped widget set via this client's local user interface framework. At said server, said frame buffer representation of said user interface is then generated from said memory model representation via conversion. Said server then effectively is capable of generating two different types of representations of said user interface, wherein said memory model representation is intended for clients that are capable to reconstruct said memory model representation from a transferred initial state of said memory model representation and subsequently transferred information on changes in said memory model representation, and said frame buffer representation obtained from said intermediate representation via conversion is intended for so-called “thin” clients, which may for instance have low computational complexity and/or insufficient user interface capabilities to render said memory model representation. In both cases, said device platform-specific adaptation of said representation of said user interface are nevertheless considered during said generation of both types of representations of said user interfaces.

According to a further embodiment of the server-site method of the present invention, said representation of said user interface is either a memory model representation of said user interface, which memory model representation can be transferred to said at least one client by first transferring an initial state of said memory model representation to said at least one client, and then transferring only information on changes in said memory model representation to said at least one client, or a frame buffer representation of said user interface, which frame buffer representation enables placement of said frame buffer representation in a frame buffer of said at least one client for rendering, and wherein said method further comprises determining, in dependence on said device platform of said at least one client, which of said memory model representation and said frame buffer representation is generated by said server.

For instance, if said at least one client is not able to render a memory model representation of said UI, for instance due to lack of an own UI framework, said server generates a frame buffer representation for said at least one client. Otherwise, said memory model representation may be generated. Thus according to this embodiment of the present invention, the interworking of devices with heterogeneous UI capabilities is further improved. Furthermore, for instance, said representation of said user interface may also be said enhanced memory model representation.

According to a further embodiment of the server-site method of the present invention, said representation of said user interface is transferred from said server to said at least one client via a unidirectional channel that may be multiplexed by a Blocks Extensible Exchange Protocol (BEEP).

Said unidirectional channel is directed from said server to said at least one client and may, for instance together with at least one further channel, be multiplexed by BEEP, which is defined in Request For Comments (RFC) document 3080. Said BEEP may for instance use the services of an underlying Transport Control Protocol/Internet Protocol (TCP/IP) protocol stack and may allow transfer of textual (e.g. Extensible Markup Language (XML) files) and binary information, for example. Said at least one further channel may for instance be a unidirectional key events channel that is directed form said at least one client to said server and transfers user interface related events, such as information on user interaction with said user interface, to said server.

Furthermore, for instance, said representation of said user interface may also be said enhanced memory model representation. The use of said enhanced memory model representation may lead to reduced network traffic on said unidirectional channel compared to said memory model representation and to improved responsiveness of said Blocks Extensible Exchange Protocol (BEEP).

According to a further embodiment of the server-site method of the present invention, said channel is a channel of a Lightweight Remote Display Protocol (LRDP). Thus said dedicated unidirectional channel may be an LRDP channel for transfer of frame buffer representations of said user interface, or an LRDP channel for transfer of an initial state and/or information on changes in a memory model representation of said user interface, or an LRDP channel for transfer of an initial state and/or information on changes in an enhanced memory model representation of said user interface. The use of said enhanced memory model representation may lead to reduced network traffic on said LRDP channel compared to said memory model representation and to improved responsiveness of LRDP. Furthermore, in case of applying said enhanced memory model representation, an additional LRDP BEEP channel may be used to download the runtime content of the user interface elements, wherein said runtime pointer of the user interface elements may be used for this download.

According to a further embodiment of the server-site method of the present invention, said server learns said device platform of said at least one client during set-up of said remoting of said user interface between said server and said at least one client, and retrieves said user interface description that is specific for said device platform of said at least one client based on said learned device platform of said at least one client. Said set-up of said remoting may at least partially be performed in the context of a UPnP framework. Said server may for instance have access to a database in which said platform-specific user interface descriptions are stored, and which is indexed by said device platform of said at least one client.

According to a further embodiment of the server-site method of the present invention, said user interface description obeys the XML-format. XML uses descriptive markup symbols and thus describes content in terms of what kind of data is being described. XML is “extensible” because, unlike the Hypertext Markup Language (HTML), the markup symbols are unlimited and self-defining. Thus it would be advantageous to use XML for said platform-specific user interface description as it offers the flexibility to define a wide variety of parameters for said user interface description.

According to a further embodiment of the server-site method of the present invention, said remoting of said user interface between said server and said at least one client is at least partially based on a remote user interface framework according to the Universal Plug and Play standard or a derivative thereof. Said remote user interface framework may for instance comprise a UPnP RUI client in said at least one client and a UPnP RUI server in said server.

Further, a computer program product is proposed for a server of a system for remoting a user interface of an application between said server that executes said application and at least one client on which a representation of said user interface is to be rendered, said computer program product comprising program code for causing said server to generate said representation of said user interface at said server under consideration of a user interface description that is specific for a device platform of said at least one client; and program code for causing said server to transfer said representation of said user interface to said at least one client. A central processor unit (CPU) of said server may for instance execute said program code of said computer program product.

Further, a server of a system is proposed for remoting a user interface of an application between said server that executes said application and at least one client on which a representation of said user interface is to be rendered, said server comprising means arranged for generating said representation of said user interface at said server under consideration of a user interface description that is specific for a device platform of said at least one client; and means arranged for transferring said representation to said at least one client. Said server may represent any type of electronic device that is capable of executing an application that is associated with a user interface.

Further, a module for a system is proposed for remoting a user interface of an application between a server that executes said application and at least one client on which a representation of said user interface is to be rendered, said module comprising means arranged for generating said representation of said user interface under consideration of a user interface description that is specific for a device platform of said at least one client; and means arranged for making said representation available to said server to allow said server to transfer said representation to said at least one client. Said module may for instance be incorporated into said server or connected thereto, for instance in the form of an add-on component.

Further, a computer program product for a module for a system is proposed for remoting a user interface of an application between a server that executes said application and at least one client on which a representation of said user interface is to be rendered, said computer program product comprising program code for causing said module to generate said representation of said user interface under consideration of a user interface description that is specific for a device platform of said at least one client; and program code for causing said module to make said representation available to said server to allow said server to transfer said representation to said at least one client.

Further, a client-site method is proposed for remoting a user interface of an application between a server that executes said application and a client on which a representation of said user interface is to be rendered, said method comprising obtaining said representation of said user interface at said client, wherein said representation is generated at said server under consideration of a user interface description that is specific for a device platform of said client; and taking action to render said obtained representation of said user interface.

Said client may be characterised by its device platform, and said device platform may further be defined by the client device manufacturer and/or client device series and/or client device model. Depending on said device platform, said client may have specific user interface capabilities, and/or may use a characteristic display style, for instance a characteristic appearance of a local user interface that interfaces with said clients local application(s). In order to enable adaptation of said representation of said user interface to said user interface capabilities and/or said characteristic display style (look & feel) at said client, said platform-specific user interface description, which may for instance describe how said representation of said user interface should look like when it is remoted on said client, is considered when generating said representation of said user interface at said server. The resulting representation of said user interface is then transferred to said client, obtained at said client, and action is taken by said client to render said representation of said user interface.

According to an embodiment of the client-site method according to the present invention, said representation of said user interface is a memory model representation of said user interface, said memory model representation is transferred to said client by first transferring an initial state of said memory model representation to said client, and then transferring only information on changes in said memory model representation to said client, and said client takes action to render said obtained memory model representation by obtaining said initial state and said information on changes in said memory model representation; reconstructing said memory model representation from said obtained initial state and said obtained information on changes; mapping said widget set described by said memory model representation to said client's own widget set; and displaying said mapped widget set via said client's local user interface framework.

Said memory model reconstruction may for instance be reconstructed by generating a replica of said memory model representation. Said client's local user interface framework may for instance comprise functionality that is used by said client to render user interfaces for its local applications.

Furthermore, for instance, the memory model representation may be enhanced by comprising not the content of each user interface element of the corresponding user interface description. Thus, it would be possible to mark at least one user interface element of the corresponding user interface description as optional and to transfer the content of the remaining user interface elements within the enhanced memory model representation without transferring the content of said at least one user interface element marked optional, leading to reduced network traffic and to decreased power consumption in said at least one client receiving said enhanced memory model representation. In particular, in case that at least one of said at least one client is represented by a mobile client, this decreased power consumption increases battery lifetime. At least one of said at least one client receiving said enhanced memory model may decide whether or not to download runtime content of at least one of said at least one user interface element marked optional. Furthermore, the user interface elements in the enhanced memory model may contain a property that points to the runtime content, in particular, said at least one user interface element marked optional in said enhanced memory model may comprise a runtime pointer to the content of said at least one user interface element marked optional. Thus, if said at least one of said at least one client selects at least one of said at least one user interface element marked optional for download, the runtime content of said at least one selected element may be transferred to said at least one of said at least one client by using the runtime pointer to the runtime content of said at least one selected element.

According to a further embodiment of the client-site method according to the present invention, said representation of said user interface is a frame buffer representation of said user interface, said frame buffer representation enabling placement of said frame buffer representation in a frame buffer of said client for rendering, and said client takes action to render said obtained frame buffer representation by placing said frame buffer representation into a frame buffer of said client for rendering.

Said rendering may for instance comprise digital-to-analog conversion of said frame buffer representation, for instance performed by a RAMDAC, and displaying of the analog signals obtained from said digital-to-analog conversion on a presentation medium, for instance a cathode ray tube, a liquid crystal display, a plasma display, or any other type of display unit. Said client then may for instance be a so-called thin client with limited computational power and/or with limited user interface capabilities that are for instance not sufficient to render a memory model representation of said user interface.

Further, a computer program product is proposed for a client of a system for remoting a user interface of an application between a server that executes said application and said client on which a representation of said user interface is to be rendered, said computer program product comprising program code for causing said client to obtain said representation of said user interface at said client, wherein said representation is generated at said server under consideration of a user interface description that is specific for a device platform of said client; and program code for causing said client to take action to render said obtained representation of said user interface. A central processor of said client may for instance execute program code of said computer program product.

Further, a client of a system is proposed for remoting a user interface of an application between a server that executes said application and said client on which a representation of said user interface is to be rendered, said client comprising means arranged for obtaining said representation of said user interface at said client, wherein said representation is generated at said server under consideration of a user interface description that is specific for a device platform of said client; and means arranged for taking action to render said obtained representation of said user interface. Said client may represent any type of electronic device that is capable of rendering said representation of said user interface.

Further, a system for remoting a user interface of an application is proposed, said system comprising a server that executes said application, and at least one client on which a representation of said user interface is to be rendered, wherein said server comprises means arranged for generating said representation of said user interface at said server under consideration of a user interface description that is specific for a device platform of said at least one client; and means arranged for transferring said representation to said at least one client; and wherein said at least one client comprises means arranged for obtaining said representation of said user interface at said at least one client; and means arranged for taking action to render said obtained representation of said user interface. Said system may for instance be a part of a UPnP network.

These and other aspects of the invention will be apparent from and elucidated with reference to the embodiments described hereinafter.

### BRIEF DESCRIPTION OF THE FIGURES

In the figures show:

FIG. 1: A block diagram of a first exemplary embodiment of a system according to the present invention;

FIG. 2: a block diagram of a second exemplary embodiment of a system according to the present invention;

FIG. 3: a block diagram of a third exemplary embodiment of a system according to the present invention;

FIG. 4a: a schematic illustration of a protocol stack for the first embodiment of a system according to the present invention;

FIG. 4b: a schematic illustration of a protocol stack for the second embodiment of a system according to the present invention;

FIG. 4c: a schematic illustration of a protocol stack for the third embodiment of a system according to the present invention;

FIG. 4d: a schematic illustration of a protocol stack for the fourth embodiment of a system according to the present invention

FIG. 5: a flowchart of a server-site method performed by a server in the first, second and third embodiment of a system according to the present invention;

FIG. 6: a flowchart of a client-site method performed by a client in the first or third embodiment of a system according to the present invention; and

FIG. 7: a flowchart of a client-site method performed by a client in the second or third embodiment of a system according to the present invention; and

FIG. 8: a block diagram of a fourth exemplary embodiment of a system according to the present invention; and

FIG. 9: a flowchart of a server-site method performed by a server in the fourth embodiment of a system according to the present invention; and

FIGS. 10a+10b: a flowchart of a client-site method performed by a client in the fourth embodiment of a system according to the present invention.

### DETAILED DESCRIPTION OF THE INVENTION

The present invention relates to the field of remoting a User Interface (UI) of an application between a server that executes said application and a client on which a representation of said user interface is to be rendered. In order to enable adaptation of the representation of said UI to the UI capabilities and/or the characteristic display style of the device platform of the client on which said representation of said UI is rendered, the present invention proposes to consider a platform-specific UI description during a generation of said representation of said UI at a server, which representation can then be transferred to the client for rendering.

In the following detailed description, the present invention will be described by means of exemplary embodiments, which shall by no means be understood to limit the scope of the present invention.

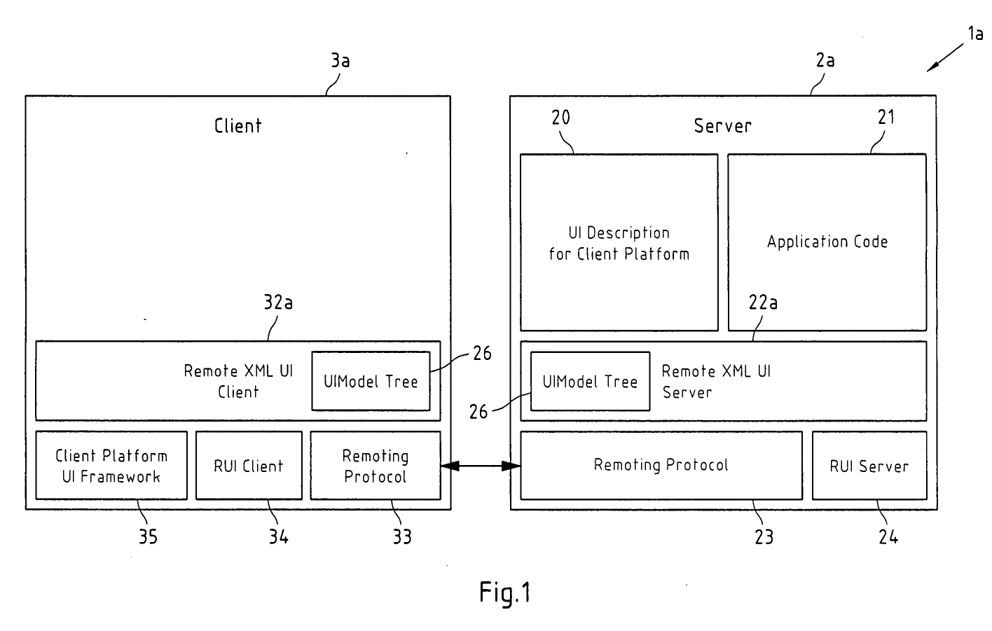

FIG. 1 is a block diagram of a first exemplary embodiment of a system 1a according to the present invention. The system 1a comprises a server 2a and a client 3a, wherein server 2a and client 3a are capable of remoting a UI of an application that is executed by server 2a between server 2a and client 3a.

Server 2a comprises an application code 21 that implements the application that is executed by server 2a, wherein this application may for instance be related to the main functionality of server 2a. For instance, server 2a may be a video recorder, and then this application may be the rendering of video streams. The application code may for instance be binary code (in case of C++ applications), bytecode (in case of Java applications), a script or similar code. This application can be controlled and/or monitored via a UI which, to stay in the example of the server 2a being a video recorder, may for instance be a menu structure for the video recorder. Said UI may for instance be composed of a plurality of widgets, wherein said widgets represent elements of said user interface that display information or provide a specific way for a user to interact with an application, for instance icons, pull-down menus, buttons, selection boxes, and similar interaction or display elements.

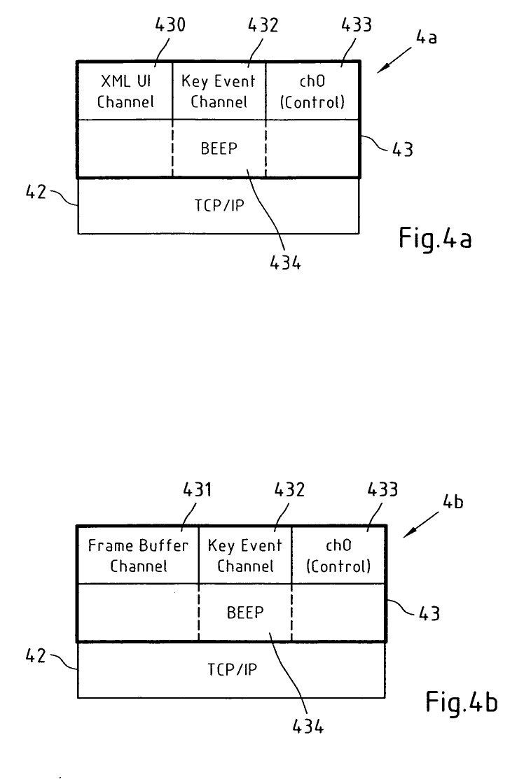

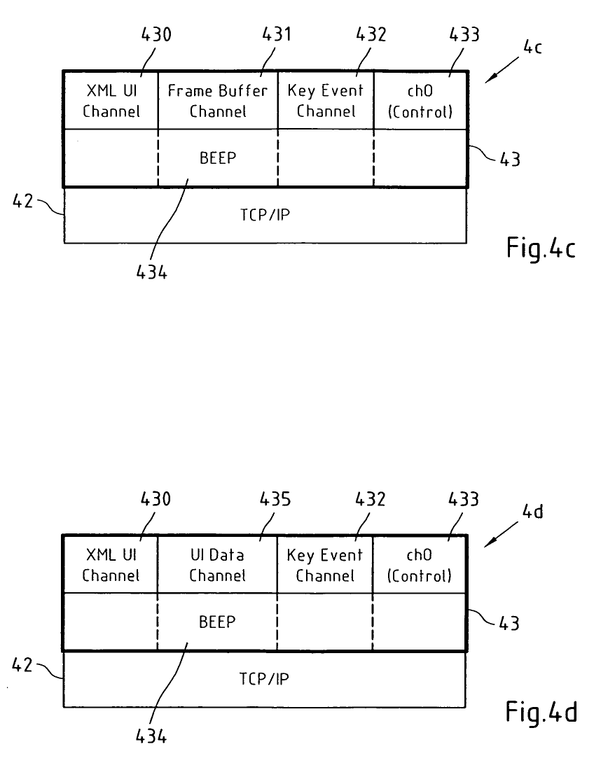

In the system 1a of FIG. 1, the Remote User Interface (RUI) server 24 of server 2a cooperates with the RUI client 34 in client 3a to check for compatibility between server 2a and client 3a during a connection set-up phase. Therein, RUI server 24 and RUI client 34 may for instance be Universal Plug and Play (UPnP) RUI servers and clients, respectively. RUI server 24 and RUI client 34 use respective instances 23 and 33 of a remoting protocol to set up an at least logical connection between server 2a and client 3a, which connection then is used to exchange information related to the remoting of the UI of the server's application. In FIG. 1, this connection is indicated as an arrow between instances 23 and 33. More details on the remoting protocol implemented by instances 23 and 33 and the information transferred via this connection will be given with reference to FIGS. 4a-4c below.

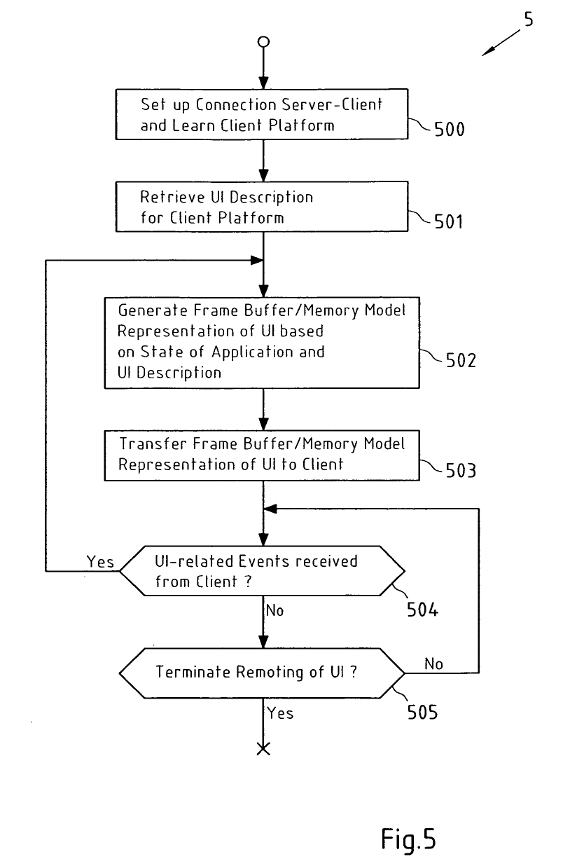

Server 2a further comprises a UI description 20 related to the specific device platform of client 3a. This platform-specific UI description may for instance specify how a representation of a UI should look like when it is remoted to client 3a. Said platform-specific UI description 20 may for instance define the complete layout of widgets of said representation of said user interface for rendering on said client 3a. Therein, in particular the style and/or colour and/or further features of said widgets that are characteristic for a display style of said client, for instance a display style of said widgets in said client's 3a local UI, may be considered. To this end, UI description 20 may for instance consist of a plurality of XML files and/or style sheets, for instance according to the Cascading Style Sheets Version 2 (CSS2) standard. Such a platform-specific UI description 20 may for instance be retrieved by server 2a during the set-up of a connection between server 2a and client 3a, as will be explained in more detail with reference to FIG. 5 below. According to the present invention, said UI description 20 is separated from the application code 21 in order to enable adaptation of the representation of the UI to the UI capabilities and/or the characteristic display style of the device platform of the client 3a.

An application executed by said server 2a generally has one associated application code 21 and may have one or more platform-specific UI descriptions 20 depending on how many remote device platforms are supported by the respective application.

Applications may for instance list the device platforms they support in UI listings that are maintained by the RUI server 24 of server 2a. The RUI client 34 in client 3a, in turn, may maintain a device profile with an identifier of its device platform such as a device platform name.

Server 2a further comprises a remote XML UI server 22a, which cooperates with a remote XML UI client 32a in client 3a. The role of the remote XML UI server 22a is to create a memory model representation 26 of the UI, which is denoted as UIModelTree in FIG. 1. The memory model representation 26 is created from the platform-specific UI description 20 for a remote device platform whenever the server application needs to export the display (i.e. remote the UI) to that particular platform. This memory model representation 26 thus describes the widget set of the UI under consideration of the platform-specific UI description 20 and possibly the current state of the server application. As its name implies, the memory model representation 26 lends itself for description via an initial state of said memory model representation 26, and changes with respect to previous (memorized) states of said memory model representation 26. When the UI has changed due to user interaction and/or changes in the state of the server application (e.g. due to a user activating a pull-down menu), it is then not required to re-transmit the complete memory model representation to the client 3a, but only transmission of the information on changes in the memory model representation to the client 3a are required. This may reduce the amount of data that has to be exchanged between server 2a and client 3a.

This memory model representation 26 is transferred (in terms of its initial state and of information on subsequent changes) to client 3a via the connection between server 2a and client 3a. Said initial state may for instance be transmitted as a collection of text files such as XML and/or CSS descriptions, or as a binary encoded Document Object Model (DOM) object. Said information on said changes may for instance be transmitted as XPATH objects. Alternatively, the remote XML UI server can update the changes to the remote XML UI client memory representation using an additional LRDP BEEP channel, through which remote procedure calls are executed. For instance the remote XML UI server can execute an action (UpdateUIModelTree) that has as arguments a pointer to the node that is changed and also the change. The remote procedure call mechanism used can be SOAP.

At client 3a, the remote XML UI client 32a is capable of generating a replica 26 of the memory model representation 26 (denoted as UIModelTree in FIG. 1) based on the received initial state and the received information on changes (that can be considered as update information) of the memory model representation 26. The remote XML UI client 32a of client 3a is further capable of interacting with a client platform UI framework 35 to map the widget set described by the replica 26 of the memory model representation 26 of the UI to the client's 3a own widget set, so that the memory model representation 26 of the UI can be displayed on a display of client 3a.

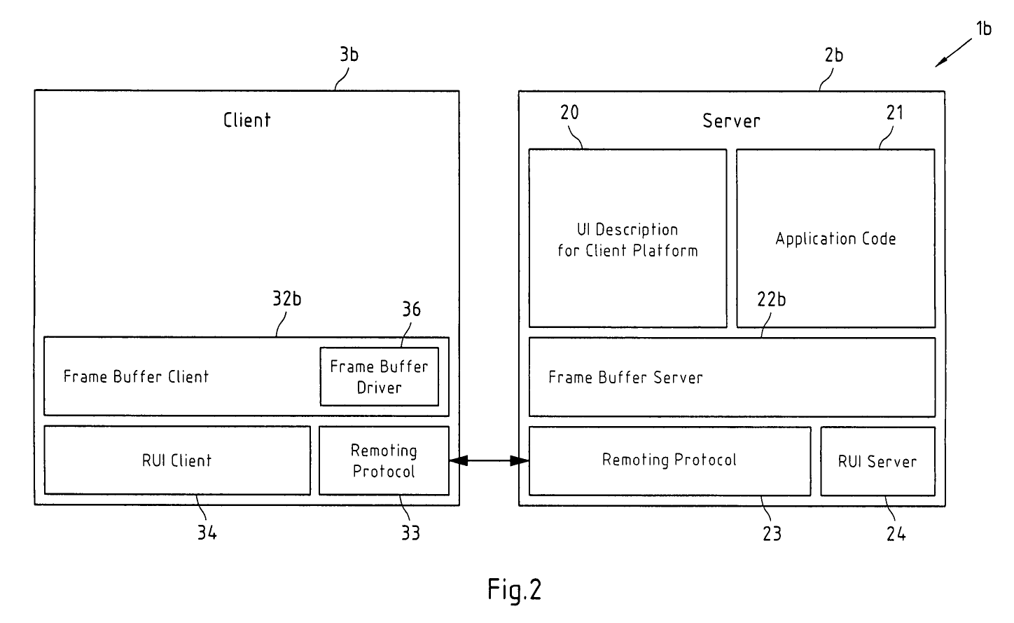

FIG. 2 depicts a block diagram of a second exemplary embodiment of a system 1b according to the present invention. In FIG. 2, components of the system 1b that have the same functionality as components in the system 1a of FIG. 1 are denoted by the same reference numerals.

Instead of the Remote XML UI server 22a, which generates the memory model representation 26 of the UI in the server 2a of system 1a according to FIG. 1, the server 2b of system 1b according to FIG. 2 comprises a frame buffer server 22b. The frame buffer server 22b is responsible for generating, depending on the platform-specific UI description 20 and possibly the current state of the server's application, a frame buffer representation of the UI. This frame buffer representation may be imagined as a screen dump of the current layout of the widgets of the UI (based on the UI description and possibly a state of the application) in a format suited for buffering in a frame buffer of client 3b. This frame buffer representation can be exchanged between server 2b and client 3b based on the remoting protocol instances 23 and 33.

Client 3b comprises a frame buffer client 32b, which receives the frame buffer representation of the UI from server 2b via the remoting protocol, places the frame buffer representation of the UI in a frame buffer of client 3b and triggers a frame buffer driver 36 that controls the frame buffer in order to render contents of the frame buffer on a display of client 3b. As the frame buffer representation of the UI is already in frame buffer format (due to the processing at server 2b), direct rendering of the frame buffer representation may be possible without requiring further processing or mapping (apart from digital-to-analog conversion) of the frame buffer representation of the UI. As a consequence, client 3b, in contrast to client 3a (see FIG. 1), does not have to provide a client platform UI framework 35, but nevertheless is capable of remoting a UI.

The frame buffer of client 3b may for instance be a Video Random Access Memory (VRAM) in which the frame buffer representation of the UI can be buffered before it is digital-to-analog converted (for instance by a Random Access Memory Digital-to-Analog converter (RAMDAC)) to obtain an analog signal that is then fed into a display unit such as for instance a cathode ray tube, a liquid crystal display, a plasma display or similar display units. The frame buffer may be logically arranged as a rectangular array of pixels that correspond to pixels of the display unit, and a frame buffer format then may for instance assign each of the pixels a colour being coded with a limited bit depth.

For the first embodiment of a system 1a (see FIG. 1) according to the present invention, it was assumed that client 3a on which a UI of the server application is to be remoted provides a remote XML UI client 32 a and a client platform UI framework 35, so that client 3a is capable of rendering said memory model representation of said UI. For the second embodiment of a system 1b (see FIG. 2) according to the present invention, it was assumed that client 3b only provides a frame buffer client 32b that allows said client 3b to render a frame buffer representation of said UI, without requiring high computational complexity and without requiring an own UI framework. In both embodiments, the servers 2a and 2b were tailored to the UI capabilities of the clients 3a and 3b. According to a third embodiment of the present invention, now a server 3c will be described that is capable of remoting UIs to both types of clients 3a and 3b.

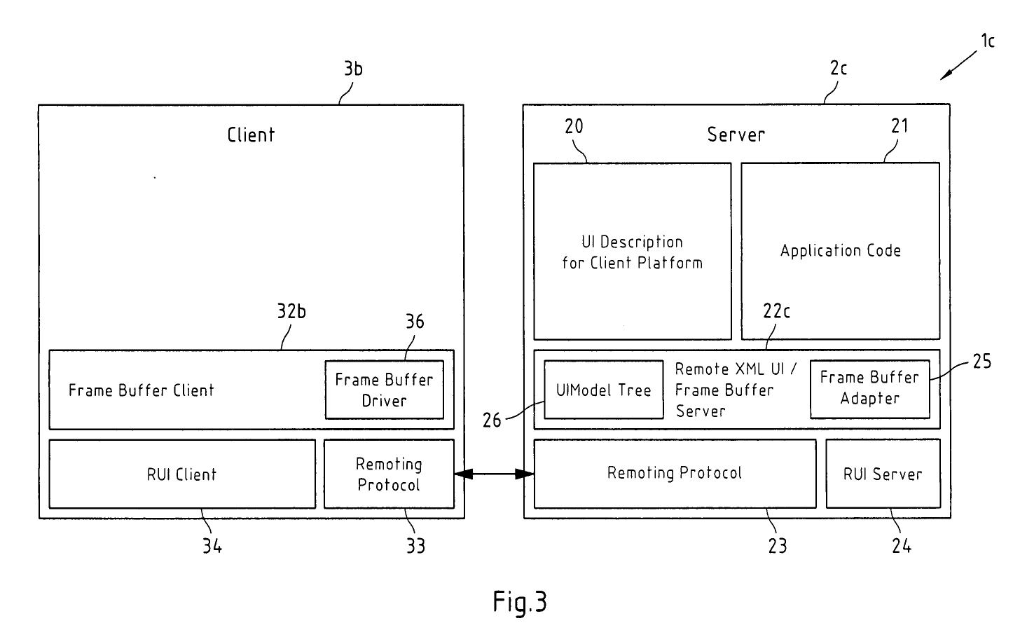

FIG. 3 depicts a block diagram of the corresponding third embodiment of a system 1c according to the present invention. System 1c comprises server 2c, and exemplarily a client 3b that equals the client 3b of the system 1b (see FIG. 2). It is readily understood that, equally well, client 3a (see FIG. 1) could have been depicted in FIG. 3 instead of client 3b, because said server 3c is capable of exporting its UI to both types of clients.

Server 2c basically has the same components as server 2a of the system 1a (see FIG. 1). However, the remote XML UI server 22a of server 2a has been extended to a remote XML UI/frame buffer server 22c. This remote XML UI/frame buffer server 22c is capable of generating both a memory model representation 26 (denoted as UIModelTree in FIG. 3) and a frame buffer representation of a UI for an application that is executed by said server 2c and represented by application code 21. This is accomplished by the frame buffer adapter 25, which is capable of converting a memory model representation 26 of the UI into a frame buffer representation. In the generation of both types of representations, the platform-specific UI description 20 is considered, so that the generated representations are adapted to the local display style of the respective clients. Both types of representations then can be transferred to clients 3a or 3b via a remoting protocol.

Remote XML UI/frame buffer server 22c may for instance decide based on information on the device platform of a client if it is sufficient to generate the memory model representation 26, or if, in a further conversion step, the frame buffer representation has to be created from the memory model representation 26. Such information may equally well be contained in the platform-specific UI description 20.

It is readily understood that the remote XML UI/frame buffer server 22c may equally well be implemented so that an independent generation of the memory model representation 26 on the one hand, and the frame buffer representation on the other hand is possible. Said remote XML UI/frame buffer server 22c then may for instance comprise a separate remote XML UI server 22a as in FIG. 1, and a frame buffer server 22b as in FIG. 2.

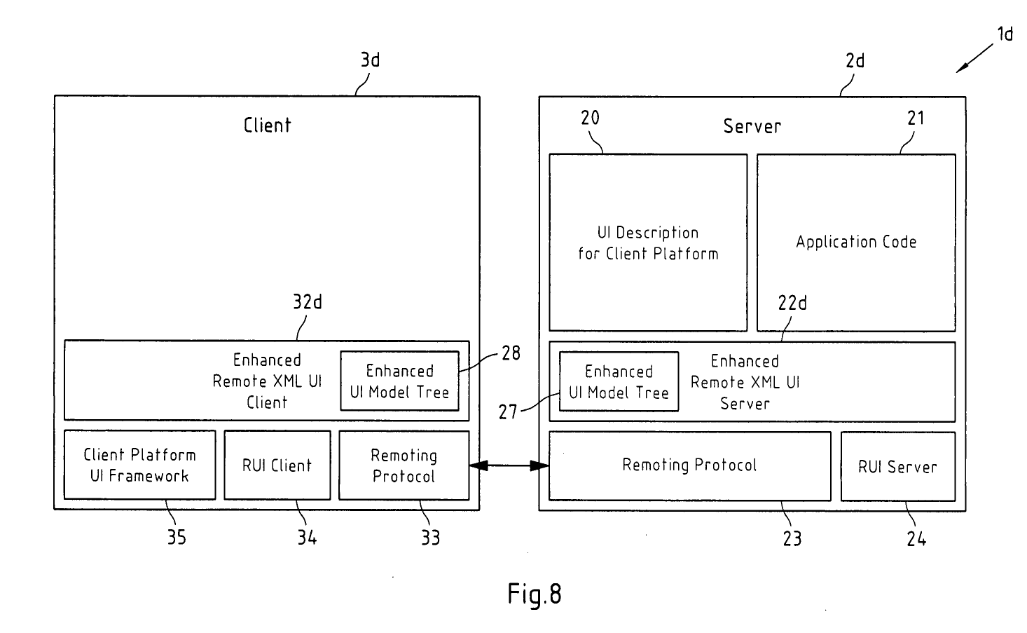

FIG. 8 depicts a block diagram of the corresponding fourth embodiment of a system 1d according to the present invention. In FIG. 8, components of the system 1d that have the same functionality as components in the system 1a of FIG. 1 are denoted by the same reference numerals. Server 2d basically has the same components as server 2a of the system 1a (see FIG. 1), and the client 3d basically has the same components as client 3a of the system 1a (see FIG. 1).

In contrast to the Remote XML UI server 22a, which generates the memory model representation 26 of the UI in the server 2a of system 1a according to FIG. 1, the server 2d of system 1d according to FIG. 8 comprises an enhanced Remote XML UI server 22d which generates an enhanced memory model representation 27 of the UI. This enhanced memory model representation 27 is denoted as Enhanced UIModelTree in FIG. 8. Similarly to the memory model representation 26 of the first embodiment, this enhanced memory model representation 27 is created from the platform-specific UI description 20 for a remote device platform whenever the server application needs to export the display (i.e. remote the UI) to that particular platform, but, contrary to the memory model representation 26, the enhanced memory model representation 27 does not comprise the run-time content of each UI element of the corresponding platform-specific UI description 20. Thus, it is possible, that at least one UI element (i.e. widget) is marked optional and the run-time content of this at least one UI element is not included in the enhanced memory model 27 for transmitting to the client 3d. For instance, it may be challenging to have that kind of content included in the UI description of the enhanced memory model 27, which is an XML based language, and to mark that kind of UI elements optional which are used to present in the UI large amounts of data that are available only at runtime to exclude the runtime-content of these marked UI elements. Thus, the server 2d, while transmitting the enhanced memory model, does not transmit the runtime content of the marked UI elements leading to reduced network traffic. Furthermore, the UI elements (i.e. widgets) in the UI description of the enhanced memory model 27 have a new property that points to the runtime content (i.e. an URL).

This enhanced memory model representation 27 may also possibly describe the current state of the server application according to memory model representation 26 of the first exemplarily embodiment, and, as its name implies, the enhanced memory model representation 27 lends itself for description via an initial state of said enhanced memory model 27, and changes with respect to previous (memorized) states of said enhanced memory model representation 27. When the UI has changed due to user interaction and/or changes in the state of the server application (e.g. due to a user activating a pull-down menu), it is not required to re-transmit the complete enhanced memory model representation 27 to the client 3d, but only transmission of the information on changes in the enhanced memory model representation to the client 3d is required. This may reduce the amount of data that has to be exchanged between server 2d and 3d.

This enhanced memory model representation 27 is transferred to client 3d via the connection between server 2d and client 3d according to the first exemplary embodiment.

At client 3d, an enhanced remote XML UI client 32d is capable of generating a replica 28 of the enhanced memory model representation 27 (denoted as enhanced UIModelTree in FIG. 8) based on the received initial state and the received information on changes according to the explanations concerning the remote XML UI client 32a of the first exemplarily embodiment. Furthermore, the client 3d decides whether or not runtime content of the at least one UI element marked optional should be downloaded, and the corresponding UI elements are selected. This decision may depend on the data size of the runtime content of the UI elements, or, in case that a UI element represents an image, the decision whether or not to load the runtime content of this image may depend whether there is enough space in the device to fit other panels and the statuspane of said image. Based on said decision the client 3d fetches the runtime content of the selected UI elements by using the runtime pointers of said selected UI elements and this received runtime content is added to the replica 28 of the enhanced memory model representation 27. Thus, the client 3d decides which of the at least one UI element marked optional should be downloaded and rendered, leading to reduced network traffic and increased battery lifetime.

Furthermore, this decision whether or not to download runtime content of the at least one UI element marked optional may also be performed by a user via an interaction. For instance, a user may decide to download runtime content of at least one of said at least one UI element marked optional, then the client fetches the corresponding runtime content of said at least one of said at least one UI element marked optional as explained above.

For instance, the following (simplified) UI description (using S60 XMLUIML language used in XUIKON/Scale II) may be provided by the XML UI server 22d:

```
<?xml version=“1.0”?>
<xmluiml>
    <views>
      ... //some views descriptions here
    </views>
    <panes>
      <statuspane id=”sp” display-priority=”255”>
        <image path=”lrdp data://ip_address/path_to_image_file”/>
      </statuspane>
    </panes>
</xmluiml>
```

The statuspane having the name sp in this UI description has the exemplarily display priority equal to 255, which means that all status panes to be removed if the rest of the panes do not fit. This UI description is transmitted to the client 3d. Later on, for instance, the application updates the statuspane with a new image and the enhanced XML UI server 22d sends a UI update message indicating the change:
xmluiml/panes/statuspane/image path=“lrdp-data://ip_address/path_to_new_image_file”

The client 3d receives this UI update message and decides whether or not to fetch the runtime content of the image element. For instance, in case that the device does not have enough space to fit other panels the statuspane will not be rendered, and, thus, the image will also not be rendered and there is no need to fetch the runtime content of the image element. In the other case, if the device has enough space to render the statuspane the client 3d will fetch the runtime content of the image using the pointer to the runtime content provided in the widget property.

The enhanced memory model representation 27 may be not delimited to be transferred only to client 3d. For instance, client 3a of FIG. 1 is also suited to receive the enhanced memory model representation 27. In this case, the XML UI client 32a generates a replica 26 of the enhanced memory model 27 according to the first exemplarily embodiment without downloading the content of said at least one UI element marked optional.

It is readily understood that the enhanced remote XML UI server 22d may further comprise an additional frame buffer server 22c similarly to the third embodiment of the present application, so that an independent generation of the enhanced memory model representation 27 on the one hand, and the frame buffer representation on the other hand is possible.

FIG. 4a is a schematic illustration of a protocol stack 4a for the first embodiment of a system 1a (see FIG. 1) according to the present invention. The protocol stack 4a contains a plurality of channels that define a remoting protocol 43, for instance the Lightweight Remote Display Protocol (LRDP) proposed by Nokia.

In the LRDP 43, the XML UI channel 430 is a unidirectional channel that is directed from the server to the client. This XML UI channel 430 is particularly suited for the transfer of information on a memory model representation 26 of the UI from server 2a to the client 3a (cf. FIG. 1). Server 2a may for instance first send information on an initial state of the memory model representation of the UI to client 3a (for instance as a collection of text files, e.g. XML files or CSS descriptions, or as a binary encoded Document Object Model (DOM) object), and then send only information on changes of this state to client 3a (for instance as XPATH objects), wherein this information on changes may contain a pointer to a node in the memory model representation 26 (UIModelTree) that has changed and the content of the change.

The LRDP 43 further contains a key event channel 432, which is also unidirectional, and directed from client 3a to server 2a (see FIG. 1). Key events, pointing device events and any other UI related events are XML encoded at the client site and sent to the server site. The receiving server will then treat these events in a similar fashion as local UI events.

The LRDP 43 further contains a control channel 433.

In this embodiment, BEEP 434 multiplexes the channels 430, 432 and 433 of the LRDP.

The BEEP 434 uses the services of an underlying Transport Control Protocol/Internet Protocol (TCP/IP) protocol. The services of this TCP/IP protocol may also be used by one or more protocols that enable information exchange between RUI server 24 and RUI client 34 of system 1a.

FIG. 4b is a schematic illustration of a protocol stack 4b for the second embodiment of a system 1b (see FIG. 2) according to the present invention. In contrast to the protocol stack 4a of FIG. 4a, the XML UI channel 430 of the LRDP 43 has been replaced by a frame buffer channel 431, which is unidirectional and can be used to transfer the frame buffer representation from server 2b to client 3b (see FIG. 2).

FIG. 4c is a schematic illustration of a protocol stack 4c for the third embodiment of a system 1c (see FIG. 3) according to the present invention. This protocol stack comprises both an XML UI channel 430 and a frame buffer channel 431 in the LRDP 43 to allow said server 2c to transfer both memory model representations and frame buffer representations to clients 3a and 3b, respectively.

FIG. 4d is a schematic illustration of a protocol stack 4d for the fourth embodiment of a system 1d (see FIG. 8) according to the present invention. Similarly to the first embodiment, the XML UI channel 430 is particularly suited for the transfer of information on an enhanced memory model representation 26 of the UI from server 2a to the client 3d (cf. FIG. 8) and/or to the client 3a (cf. FIG. 1). Server 2d may for instance first send the complete enhanced memory model 27 to client 3d and/or client 3a, and then send only information on changes of the enhanced memory model representation 27. In addition to the protocol stack 4a of FIG. 4a, the protocol stack 4d further comprises a UI data channel 435 in the LRDP 43 to allow the client 3d to download the runtime content of the UI elements contained in the enhanced memory model 27 provided by the server 2d. According to the fourth embodiment, this UI data channel 435 may be used to download elements of said at least one UI element marked optional. Thus, the network traffic is reduced as the server 3d does not pushes blindly the content of all UI elements and/or UI updates which also leading to improved responsiveness of LRDP. Optional, similarly to the protocol stack 4c, the protocol stack 4d may further comprise an additional frame buffer channel 431 in the LRDP 43 to allow said server 2c to transfer both enhanced memory model representations and frame buffer representations to clients 3a, 3b and 3d, respectively.

It is to be understood that the LRDP channels in FIG. 4 should be seen as logical channels in this exemplary embodiment. They may also have more than one physical BEEP channels.

FIG. 5 illustrates a flowchart 5 of an exemplary embodiment of a server-site method according to the present invention. This method may for instance be performed by servers 2a, 2b and 2c (see FIGS. 1-3) according to all three exemplary embodiments of a system according to the present invention when remoting a UI to a client 3a or 3b.

In a first step 500, a connection between the server and the client is set up, and the server learns a device platform of the client. The prerequisite for this step is that a server application that is able to remote its UI to a client has registered in the remote RUI framework by indicating to the RUI server 24 (cf. FIGS. 1-3) the device platforms that the application is able to support. This information will then be available for RUI control points (e.g. UPnP RUI control points) via RUI actions (e.g. UPnP RUI actions). The RUI Control Protocol (CP), for instance the UPnP RUI CP, may then look at the device profile of the RUI client for a client's device platform name and then identify the RUI servers that are able to remote a UI to the device platform.

It is thus possible to attempt to find a client that is supported by the server application (i.e. the server application has a platform-specific UI description for the respective device platform of the client and both server and client are using the same remoting protocol, for instance LRDP). If this attempt is successful, the LRDP parameters required for setting up the connection between server and client can be negotiated. Both the attempt to find the client and to negotiate the LRDP parameters are performed by using the RUI framework, for instance the UPnP RUI framework.

After the set-up of the connection between server and client and the learning of the client's device platform by the server, the platform-specific UI description is retrieved by the server in step 501, for instance by loading it from a data base.

In a step 502, a memory model representation (for system 1a and possibly system 1c) or a frame buffer representation (for system 1b and possibly system 1c) of the UI is generated by the server, wherein both types of representations are based on the platform-specific UI description retrieved in step 501 and possibly a current state of the server application.

In a step 503, the generated representation is transferred to the client, for instance in terms of an initial state and information on subsequent changes in case of a memory model representation (via the XML UI channel 430 of the protocol stacks 4a (see FIG. 4a) or 4c (see FIG. 4c)), or via the frame buffer channel 431 of the protocol stacks 4b (see FIG. 4b) or 4c (see FIG. 4c) in case of a frame buffer representation.

In step 504, it is then checked at the server if UI-related events have been received from the client, which events may trigger a change of the UI. If this is the case, the flowchart loops back to step 502 and generates a refreshed representation of the UI. Otherwise, the flowchart proceeds to step 505 and checks whether the remoting of the UI shall be terminated. If this is not the case, the flowchart loops back to step 504, otherwise, the remoting of the UI is terminated.

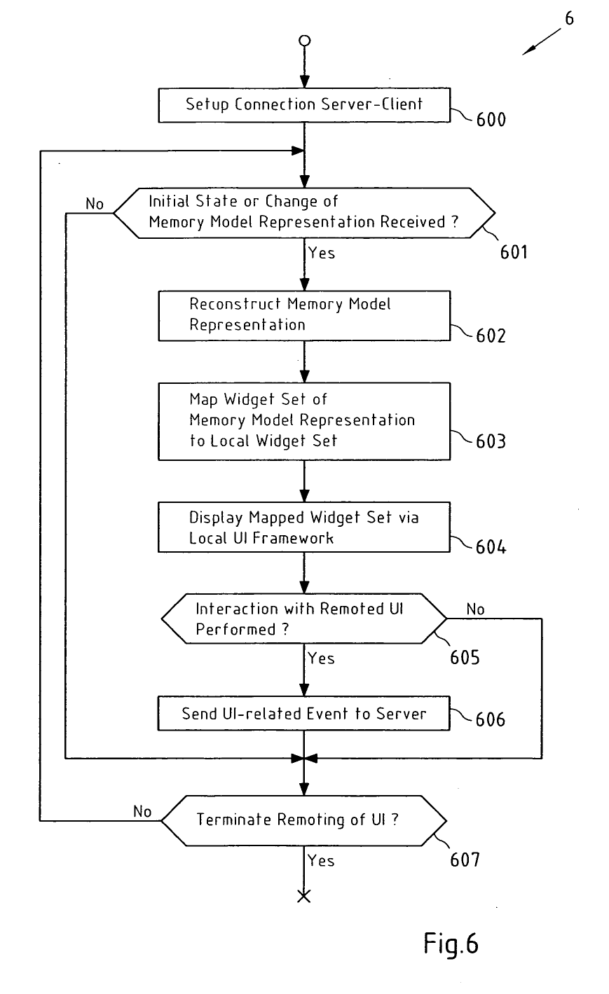

FIG. 6 illustrates a flowchart 6 of a client-site method performed by a client that is capable of rendering a memory model representation of a UI, as for instance client 3a in systems 1a and 1c of the present invention (see FIGS. 1 and 3).

In a first step 600, a connection between the server and the client is set up, as already described above with reference to step 500 of the flowchart 5 of FIG. 5.

In a step 601, the client checks if an initial state or information on changes of a memory model representation have been received from the server. If this is the case, in a step 602, the client reconstructs said memory model representation at said server by generating a replica of said memory model representation.

In a step 603, then the widget set of the UI described by the memory model representation is mapped to the local widget set of the client, and this mapped widget set is then displayed in a step 604 via the local UI framework of the client (i.e. the client platform UI framework 35 of client 3a, see FIG. 1).

In a step 605, it is then checked if a user has performed interaction with the UI. If this is the case, a UI-related event is sent to the server in a step 606 to notify the server of the interaction.

Finally, in step 607 it is checked if the remoting of the UI shall be terminated. This step is also performed if the checks in step 601 and 605 yield negative results. If termination of remoting of the UI is desired, the remoting is terminated. Otherwise, the flowchart loops back to step 601 and checks for the reception of further information on changes in the memory model representation that trigger an anew reconstruction (or update) of the memory model representation.

It is to be understood that the above-described client-side method according to FIG. 6 is also suited to process the enhanced memory model representation of the fourth embodiment. In this case, a replica of the enhanced memory model representation is generated in step 602 without downloading the content of said at least one UI element marked optional.

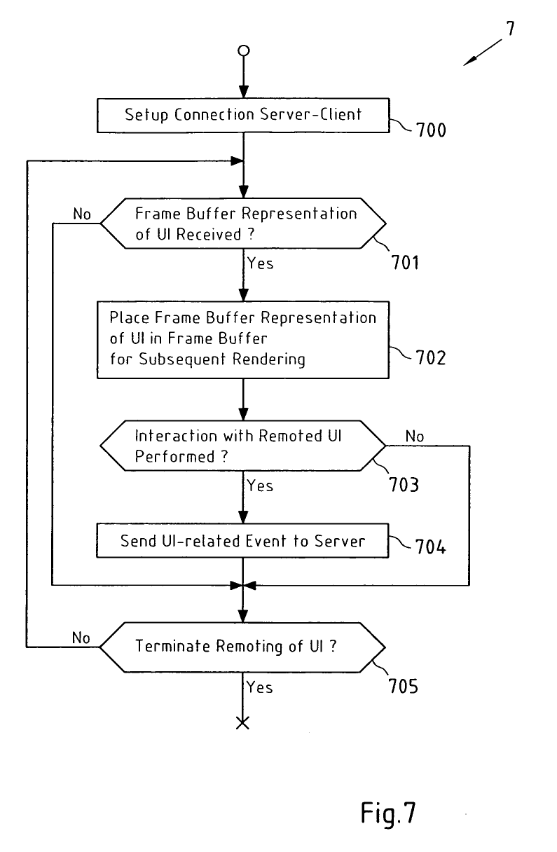

FIG. 7 illustrates a flowchart 7 of a client-site method performed by a client that is only capable of rendering a frame buffer representation of a UI, as for instance client 3b in systems 1b and 1c of the present invention (see FIGS. 2 and 3).

In a first step 700, a connection between the server and the client is set up, as already described above with reference to step 500 of the flowchart 5 of FIG. 5.

In a step 701, the client checks if a frame buffer representation of the UI is received from the server. If this is the case, in a step 702, this frame buffer representation of the UI is placed in the frame buffer of the client for subsequent rendering on a display of the client.

In a step 703, it is then checked if a user has performed interaction with the UI. If this is the case, a UI-related event is sent to the server in a step 704 to notify the server of the interaction.

Finally, it is checked in step 705 if the remoting of the UI shall be terminated. This step is also performed if the checks in step 701 and 703 yield negative results. If termination of remoting of the UI is desired, the remoting is terminated. Otherwise, the flowchart loops back to step 701 and checks for the reception of further frame buffer representations.

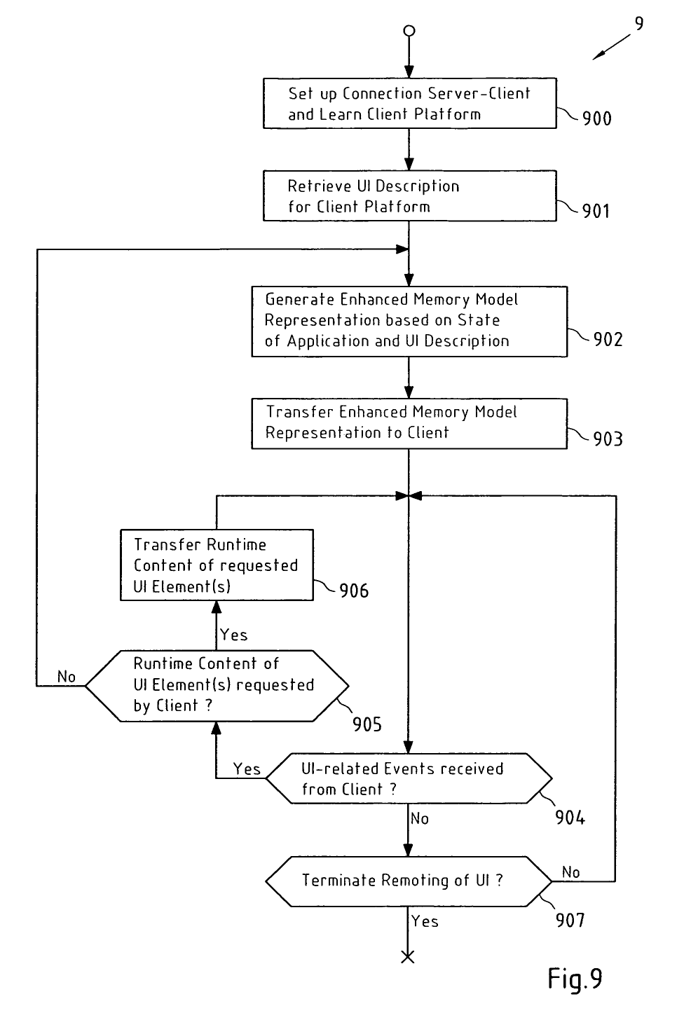

FIG. 9 illustrates a flowchart 9 of an exemplary embodiment of another server-site method according to the present invention. This method may for instance be performed by server 2d (see FIG. 8) according to the fourth exemplary embodiment of a system according to the present invention when remoting a UI to a client 3d.

In a first step 900, a connection between the server and the client is set up, and the server learns a device platform of the client. The prerequisite for this step is that a server application that is able to remote its UI to a client has registered in the remote RUI framework by indicating to the RUI server 24 (cf. FIG. 8-) the device platforms that the application is able to support. This information will then be available for RUI control points (e.g. UPnP RUI control points) via RUI actions (e.g. UPnP RUI actions). The RUI Control Protocol (CP), for instance the UPnP RUI CP, may then look at the device profile of the RUI client for a client's device platform name and then identify the RUI servers that are able to remote a UI to the device platform.

It is thus possible to attempt to find a client that is supported by the server application (i.e. the server application has a platform-specific UI description for the respective device platform of the client and both server and client are using the same remoting protocol, for instance LRDP). If this attempt is successful, the LRDP parameters required for setting up the connection between server and client can be negotiated. Both the attempt to find the client and to negotiate the LRDP parameters are performed by using the RUI framework, for instance the UPnP RUI framework.

After the set-up of the connection between server and client and the learning of the client's device platform by the server, the platform-specific UI description is retrieved by the server in step 901, for instance by loading it from a data base.

In a step 902, an enhanced memory representation (for system 1d) of the UI is generated by the server based on the platform-specific UI description retrieved in step 901 and possibly a current state of the server application. Thus, at least one UI element (i.e. widget) of the retrieved UI description is marked optional and the run-time content of this at least one UI element marked optional is not included in the enhanced memory model representation, and, further, said at least one UI element marked optional is provided with a runtime pointer to the runtime content of said at least one UI element marked optional. Optionally, a frame buffer representation (for system 1b) of the UI is generated by the UI server in addition to the above-mentioned enhanced memory representation.

In a step 903, the generated representation is transferred to the client, for instance in terms of an initial state and information on subsequent changes (via the XML UI channel 430 of the protocol stack 4d as depicted on FIG. 4d).

In a step 904, it is then checked at the server if UI-related events have been received from the client, which events may trigger a change of the UI or which events may request the runtime content of at least one UI element. If the server received UI-related events, it is checked in a step 905 if runtime content of at least one UI element is requested by the client, and, if this is the case, the runtime content of the requested UI elements is transferred to the client in step 906 and the flowchart loops back to step 904 for checking at the server if UI-related events have been received. If it is checked in step 905 that the UI related events received from the client is no request for runtime content of UI elements, then the flowchart loops back to step 902 and generates a refreshed representation of the UI. If no UI-related events have been received in step 904, the flowchart proceeds to step 907 and checks whether the remoting of the UI shall be terminated. If this is not the case, the flowchart loops back to step 904, otherwise, the remoting of the UI is terminated.

It is to be understood that step 904 for checking at the server if UI-related events have been received and step 905 for checking whether runtime content of at least one UI element is request may be performed in a single step.

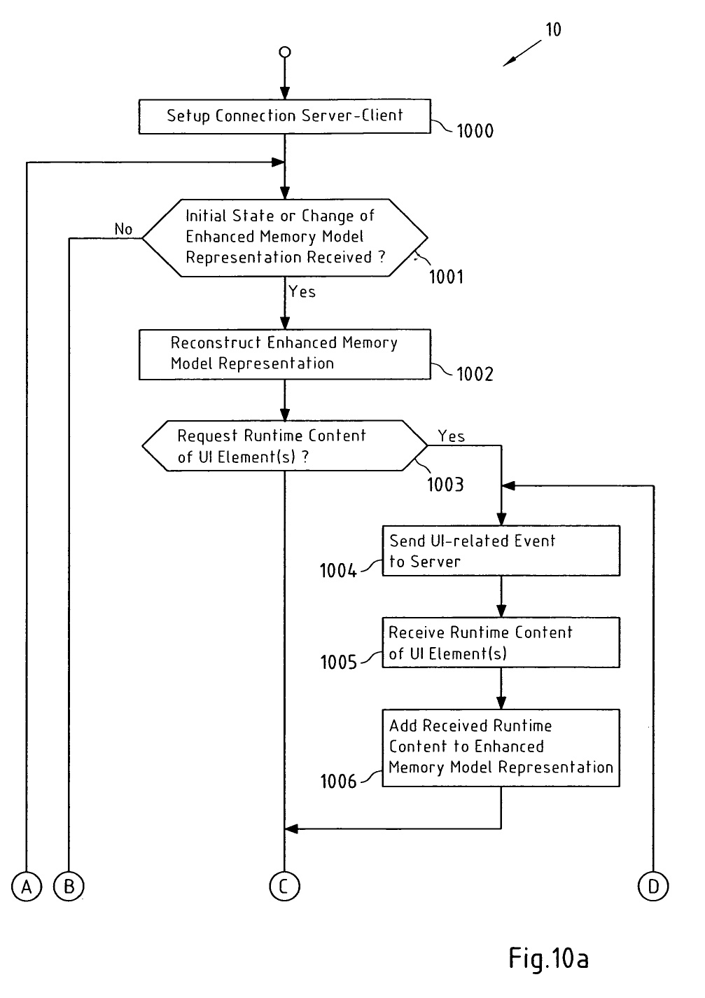

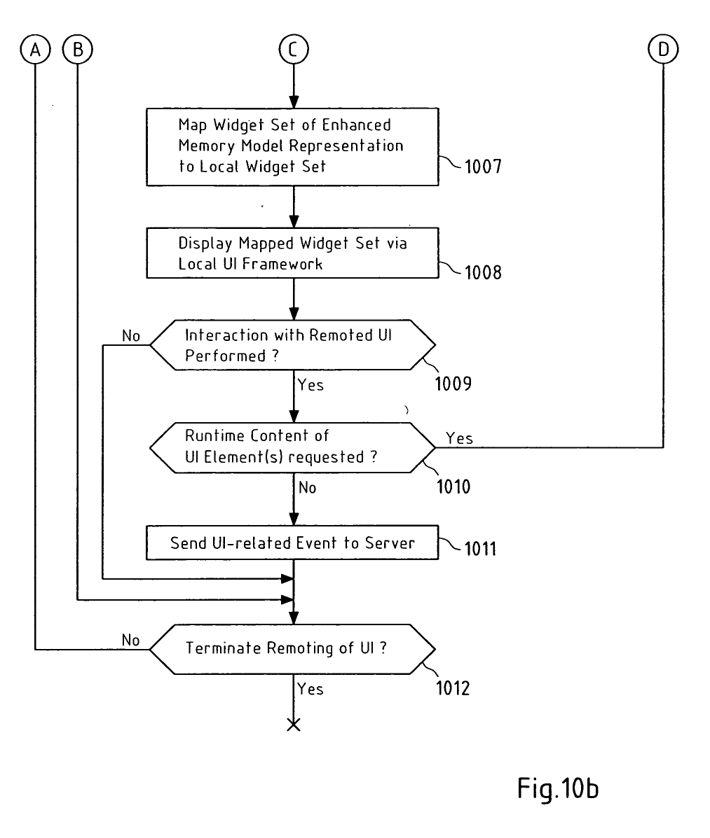

FIG. 10a and FIG. 10b illustrates a flowchart 10 of a client-site method performed by a client that is capable of rendering a enhanced memory model representation of a UI, as for instance client 3d in system 1d of the present invention (see FIG. 8).

In a first step 1000, a connection between the server and the client is set up, as already described above with reference to step 500 of the flowchart 5 of FIG. 5.

In a step 1001, the client checks if an initial state or information on changes of a enhanced memory model representation have been received from the server. If this is the case, in a step 1002, the client reconstructs said enhanced memory model representation at said server by generating a replica of said enhanced memory model representation. Currently, this replica does not contain the runtime content of the at least one UI element marked optional in the enhanced memory model representation.

In a step 1003, it is then decided by the client whether runtime content of said at least one UI element marked optional in the received enhanced memory representation is requested from the server. If this is the case, the client selects at least one of said at least one UI element marked optional and, then, the client sends a UI-related event to the server for requesting the runtime content of said at least one selected UI element to the server at a step 1004. At a step 1005, the client then receives this requested runtime content from the server, and, in a step 1006, the received runtime content is added to said replica of the enhanced memory model representation and the flowchart proceeds to step 1007 and the widget set of the UI described by the enhanced memory model representation is mapped to the local widget set of the client. Otherwise, if the client decides in step 1003 to request no runtime content, then the flowchart directly proceeds to step 1007 for mapping the widget set.

In a step 1008, this mapped widget set is then displayed via the local UI framework of the client (i.e. the client platform UI framework 35 of client 3d, see FIG. 8).

In a step 1009, it is then checked if a user has performed interaction with the UI. If this is the case, it is checked in a step 1010 if in said interaction a user selected at least one UI element for requesting the runtime content of said selected at least one UI element for download to the client, and, then, the flowchart loops back to step 1004 for sending a UI-related event to the server for notifying that the client requests the runtime content of said at least one selected UI element. For instance, a user may decide to download the runtime content of at least one of said at least one UI element marked optional in order to view the runtime content in the mapped widget set. If it is checked in step 1010 that no runtime content is requested in said interaction, a UI-related event is sent to the server in a step 1011 to notify the server of the interaction according to the client-site method presented in FIG. 6.

Finally, in step 1012 it is checked if the remoting of the UI shall be terminated. This step is also performed if the checks in step 1001 and 1009 yield negative results. If termination of remoting of the UI is desired, the remoting is terminated. Otherwise, the flowchart loops back to step 1001 and checks for the reception of further information on changes in the memory model representation that trigger an a new reconstruction (or update) of the enhanced memory model representation.

It is to be understood that while the exemplary embodiments of the invention have been focused on the UI elements that are rendered to the display, the invention is not limited to them. The invention is equally applicable into Voice UI elements, as well as to elements utilizing haptics or gesture UI, and any combination of these.

It is to be understood that remoting the UI does not limit the possibility that the UI can be rendered in the remoting end too. Further, the UI can be rendered into multiple devices, which may be either same type or different types.

The invention has been described above by means of exemplary embodiments. It should be noted that there are alternative ways and variations, which are obvious to a skilled person in the art and can be implemented without deviating from the scope and spirit of the appended claims. In particular, the present invention is not limited to application in the context of Universal Plug and Play (UPnP). It may equally well be deployed in all other types of networks where a UI that is remoted to a client shall be adapted to the characteristic display style (look & feel) of the client.

1. A server-site method for remoting a user interface of an application between a server that executes said application and at least one client on which a representation of said user interface is to be rendered, said method comprising:
generating said representation of said user interface at said server under consideration of a user interface description that is specific for a device platform of said at least one client; and
transferring said representation of said user interface to said at least one client.

2. The method according to claim 1, wherein said representation of said user interface is a memory model representation of said user interface, and wherein said memory model representation is transferred to said at least one client by first transferring an initial state of said memory model representation to said at least one client, and then transferring only information on changes in said memory model representation to said at least one client.

3. The method according to claim 1, wherein said representation of said user interface is a frame buffer representation of said user interface, and wherein said frame buffer representation enables placement of said frame buffer representation in a frame buffer of said at least one client for rendering.

4. The method according to claim 3, wherein said frame buffer representation of said user interface is generated from a memory model representation of said user interface, wherein said memory model representation can be transferred to said at least one client by first transferring an initial state of said memory model representation to said at least one client, and then transferring only information on changes in said memory model representation to said at least one client.

5. The method according to claim 1, wherein said representation of said user interface is either a memory model representation of said user interface, which memory model representation can be transferred to said at least one client by first transferring an initial state of said memory model representation to said at least one client, and then transferring only information on changes in said memory model representation to said at least one client, or a frame buffer representation of said user interface, which frame buffer representation enables placement of said frame buffer representation in a frame buffer of said at least one client for rendering, and wherein said method further comprises:
determining, in dependence on said device platform of said at least one client, which of said memory model representation and said frame buffer representation is generated by said server.

6. The method according to claim 1, wherein said representation of said user interface is transferred from said server to said at least one client via a unidirectional channel that is multiplexed by a Blocks Extensible Exchange Protocol.

7. The method according to claim 6, wherein said channel is a channel of a Lightweight Remote Display Protocol.

8. The method according to claim 1, wherein said server learns said device platform of said at least one client during set-up of said remoting of said user interface between said server and said at least one client, and retrieves said user interface description that is specific for said device platform of said at least one client based on said learned device platform of said at least one client.

9. The method according to claim 1, wherein said user interface description obeys the Extensible Markup Language format.

10. The method according to claim 1, wherein said remoting of said user interface between said server and said at least one client is at least partially based on a remote user interface framework according to the Universal Plug and Play standard or a derivative thereof.

11. A computer program product for a server of a system for remoting a user interface of an application between said server that executes said application and at least one client on which a representation of said user interface is to be rendered, said computer program product comprising:
program code for causing said server to generate said representation of said user interface at said server under consideration of a user interface description that is specific for a device platform of said at least one client; and
program code for causing said server to transfer said representation of said user interface to said at least one client.

12. A server of a system for remoting a user interface of an application between said server that executes said application and at least one client on which a representation of said user interface is to be rendered, said server comprising:
means arranged for generating said representation of said user interface at said server under consideration of a user interface description that is specific for a device platform of said at least one client; and
means arranged for transferring said representation to said at least one client.

13. A module for a system for remoting a user interface of an application between a server that executes said application and at least one client on which a representation of said user interface is to be rendered, said module comprising:
means arranged for generating said representation of said user interface under consideration of a user interface description that is specific for a device platform of said at least one client; and
means arranged for making said representation available to said server to allow said server to transfer said representation to said at least one client.

14. A computer program product for a module for a system for remoting a user interface of an application between a server that executes said application and at least one client on which a representation of said user interface is to be rendered, said computer program product comprising:
program code for causing said module to generate said representation of said user interface under consideration of a user interface description that is specific for a device platform of said at least one client; and
program code for causing said module to make said representation available to said server to allow said server to transfer said representation to said at least one client.

15. A client-site method for remoting a user interface of an application between a server that executes said application and a client on which a representation of said user interface is to be rendered, said method comprising:
obtaining said representation of said user interface at said client, wherein said representation is generated at said server under consideration of a user interface description that is specific for a device platform of said client; and
taking action to render said obtained representation of said user interface.

16. The method according to claim 15, wherein said representation of said user interface is a memory model representation of said user interface, wherein said memory model representation is transferred to said client by first transferring an initial state of said memory model representation to said client, and then transferring only information on changes in said memory model representation to said client, and wherein said client takes action to render said obtained memory model representation by:
obtaining said initial state and said information on changes in said memory model representation;
reconstructing said memory model representation from said obtained initial state and said obtained information on changes;
mapping said widget set described by said memory model representation to said client's own widget set; and
displaying said mapped widget set via said client's local user interface framework.

17. The method according to claim 15, wherein said representation of said user interface is a frame buffer representation of said user interface, wherein said frame buffer representation enables placement of said frame buffer representation in a frame buffer of said client for rendering, and wherein said client takes action to render said obtained frame buffer representation by
placing said frame buffer representation into a frame buffer of said client for rendering.

18. A computer program product for a client of a system for remoting a user interface of an application between a server that executes said application and said client on which a representation of said user interface is to be rendered, said computer program product comprising:
program code for causing said client to obtain said representation of said user interface at said client, wherein said representation is generated at said server under consideration of a user interface description that is specific for a device platform of said client; and
program code for causing said client to take action to render said obtained representation of said user interface.

19. A client of a system for remoting a user interface of an application between a server that executes said application and said client on which a representation of said user interface is to be rendered, said client comprising:
means arranged for obtaining said representation of said user interface at said client, wherein said representation is generated at said server under consideration of a user interface description that is specific for a device platform of said client; and
means arranged for taking action to rendersaid obtained representation of said user interface.

20. A system for remoting a user interface of an application, said system comprising:
a server that executes said application, and
at least one client on which a representation of said user interface is to be rendered,
wherein said server comprises:
means arranged for generating said representation of said user interface at said server under consideration of a user interface description that is specific for a device platform of said at least one client; and
means arranged for transferring said representation to said at least one client;
and wherein said at least one client comprises:
means arranged for obtaining said representation of said user interface at said least one client; and
means arranged for taking action to render said obtained representation of said user interface.
